(19) United States
(12) Patent Application Publication
(10) Pub. No.: US 2026/0192517 A1
(43) Pub. Date: Jul. 9, 2026

(54) PCD EXTRUSION NOZZLE

(71) Applicant: Gühring KG, Albstadt (DE)

(72) Inventors: Andreas SAGR, Albstadt (DE); Zarko STEVANOVIC, Albstadt (DE); Peter HARTMANN, Strassberg (DE); Tobias FECHNER, Albstadt (DE)

(73) Assignee: Gühring KG, Albstadt (DE)

(21) Appl. No.: 19/558,430

(22) Filed: Mar. 5, 2026

Related U.S. Application Data
(63) Continuation of application No. 17/456,389, filed on Nov. 24, 2021, now Pat. No. 12,589,550.
Application No. 17/456,389 is a continuation of application No. PCT/DE2020/100346, filed on Apr. 28, 2020.

(30) Foreign Application Priority Data
May 24, 2019 (DE) 10 2019 113 993.7

(51) Int. Cl. B29C 64/209; B29C 64/118; B33Y 30/00

(52) U.S. Cl. CPC B29C 64/209; B33Y 30/00; B29C 64/118

(57) ABSTRACT

The invention relates to an extrusion nozzle (1) for processing 3D printing material, having a nozzle base (2) with a seat (22) for fastening in a 3D printing device and an outlet portion (21), said outlet portion (21) comprising a nozzle insert (3), and the nozzle base (2) consisting of a solid carbide, metal or brass and the nozzle insert (3) including a PCD (polycrystalline diamond) material.

This application is a continuation of U.S. patent application Ser. No. 17/456,389, filed Nov. 24, 2021, the entirety of which is incorporated herein by reference.

The invention relates to an extrusion nozzle for processing 3D printing material.

The invention deals with a new tool development in the field of 3D extrusion nozzles. 3D extrusion nozzles are the most important component in the case of a 3D printer because the filament is positioned by means of them and the printing speed and the print quality are largely determined.

The 3D printing material to be printed escapes in molten form through the extrusion nozzle or nozzle, respectively, during the fused deposition modeling (FDM) or fused filament fabrication (FFF), respectively. With the diameter, the extrusion nozzle determines the maximum width per line during the printing as well as the diameter of the used filament.

Extrusion nozzles made of brass are widespread due to the good thermal conductivity and low costs.

A disadvantage of 3D extrusion nozzles made of brass is that the nozzles wear quickly when using filaments, such as PEEK (polyetheretherketone) plastics, which are for the high-temperature range, or when using abrasive additives, such as, e.g., carbon fiber or boron carbide. Due to the generated steady friction, in particular the nozzle opening is ground, and the ground nozzle opening leads to deterioration of the quality of the print result.

Depending on the used filament, it can be required to use an extrusion nozzle made of a different material. It is known to use steel nozzles made of hardened steel. Extrusion nozzles of this type made of steel can also be provided with gemstone insert, for example made of ruby, in order to increase the durability and to permanently improve the print results.

In addition to the higher price, such extrusion nozzles also have the disadvantage that the temperature conductivity is worse compared to brass. In the case of such nozzles with gemstone insert, the risk of breakage is further increased.

The invention is based on the object of providing an extrusion nozzle for processing 3D printing material, which overcomes the disadvantages in the prior art and which ensures a long service life and good print quality in particular in the case of abrasive filament materials.

The object is solved by means of an extrusion nozzle for processing 3D printing material. The invention comprises advantageous designs.

The invention comprises an extrusion nozzle for processing 3D printing material comprising a nozzle body comprising a seat for fastening in a 3D printing device and an outlet portion. The outlet portion comprises a nozzle insert. The nozzle body is made of a solid carbide, metal, or brass. The nozzle insert comprises a PCD (polycrystalline diamond) material. In the case of abrasive filament materials, the PCD material has a long service life with low breaking strength. The PCD material further has a high thermal conductivity.

According to a preferred aspect, the nozzle body and the nozzle insert is formed separately. The separate design of nozzle body and nozzle insert permits the use of different materials for the production of the nozzle body and of the nozzle insert.

Particularly preferably, the nozzle body and the nozzle insert is connected to one another by means of a substance-to-substance bond. The substance-to-substance bond can be established by means of soldering in that the nozzle body and the nozzle insert are held together and a solder is applied to the connection point.

According to a particularly advantageous aspect, the solder material used for the connection of nozzle body and the nozzle insert melts starting at a temperature of 500° and more. A temperature-resistant extrusion nozzle can thus be provided, which can be used, for example, when processing PEEK plastics.

A further preferred aspect provides that the outlet portion comprises a recess on the end side. The recess has a size and shape, which is formed to be complementary to the nozzle insert at least in some sections. The recess designed in this way in the outlet portion permits a simple soldering of nozzle body and nozzle insert.

A preferred technical £ aspect provides that the nozzle insert is made completely of a PCD (polycrystalline diamond) material. This is a material with a good thermal conductivity, which transports the heat from the outlet portion to the outlet opening of the nozzle insert.

The nozzle insert advantageously has an outer contour, which is lasered from all sides. The lasered outer contour preferably has several conically tapering subareas.

The nozzle insert particularly preferably has an outlet opening with 2, 3, 4, 5, or 8 mm.

Another advantageous aspect provides that the outlet portion is formed to taper at an angle in the range of from 50° to 70°, in particular 60. This contour effects a sufficient freedom of movement of the extrusion nozzle when applying the printing material.

The nozzle insert advantageously has a front surface with a diameter of 1.5 mm. The front surface is large enough to transport sufficient heat to the tip of the extrusion nozzle, and is so small that fine structures can be printed therewith.

The nozzle insert is preferably polished at least in some sections.

The invention will be additionally described below on the basis of the example illustrated in the drawings, in which:

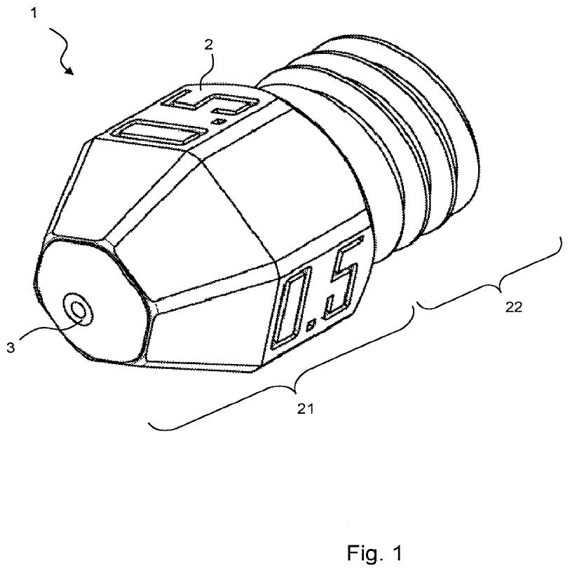

FIG. 1 shows a perspective illustration of an extrusion nozzle for processing 3D printing material according to an exemplary embodiment of the invention;

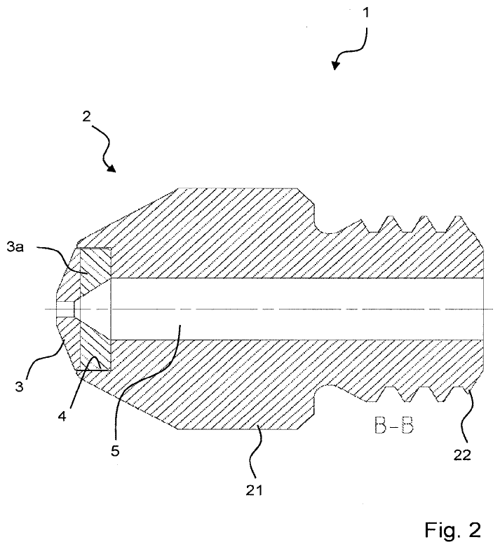

FIG. 2 shows a sectional view of a first alternative of the extrusion nozzle from FIG. 1;

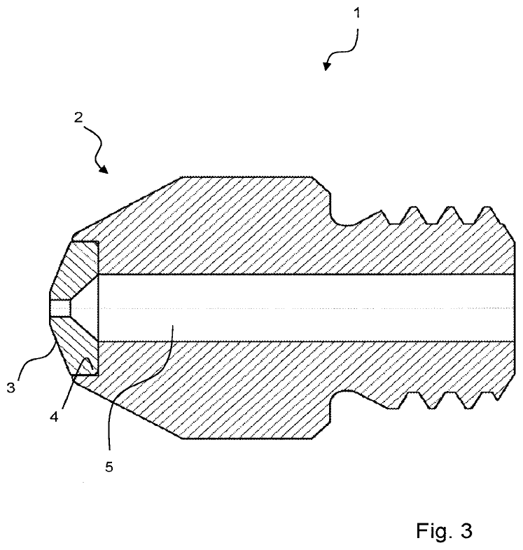

FIG. 3 shows a sectional view of a second alternative of the extrusion nozzle from FIG. 1; and

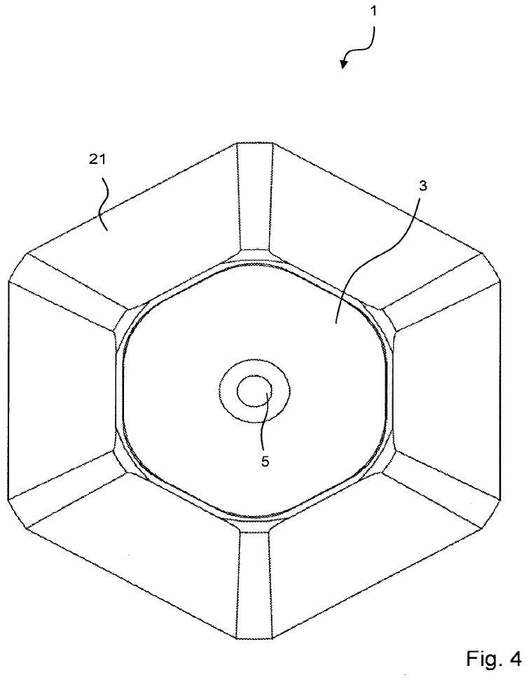

FIG. 4 shows a front view of the extrusion nozzle from FIG. 1.

A perspective view of an extrusion nozzle 1 is shown in FIG. 1, which can be attached to a printing means (not illustrated) for processing 3D printing material.

The shown extrusion nozzle 1 serves to process 3D printing material in the form of a filament. The extrusion nozzle 1 has a nozzle body 2, which has a threaded seat 22 in the rear part for screwing into the 3D printer. In the front part, the nozzle body 2 has an outlet portion 21, which is formed in one piece with the seat 22. At the front tip, the outlet portion 21 has a nozzle insert 3, which, as described further below and as illustrated in FIG. 2, continues an inner channel, which runs in the outlet channel and seat.

The nozzle body 2 and the nozzle insert 3 are formed separately. The nozzle body is made of a solid carbide, metal, or brass. The nozzle insert 3 generally comprises a PCD material, wherein the shown nozzle insert 3 is made completely of a PCD material. In the case of abrasive filament materials, the PCD material has a long service life with low breaking strength. The PCD material further has a high thermal conductivity.

The nozzle body 2 and the nozzle insert 3 are connected to one another by means of a substance-to-substance bond in the manner of a soldering point. For use at high temperatures, the solder material used for the connection of nozzle body and nozzle insert is selected in such a way that it melts starting at a temperature of 500° and more. Silver solder is one example.

The opening in the center of the nozzle insert 3 has a diameter of 5 mm, wherein the shown example is not limited to this dimension. The nozzle insert 3 has a front surface with a diameter of 1.5 mm.

In the region between nozzle insert 3 and seat 22, the outlet portion 21 has several surface portions, which are formed to taper at an angle of approximately 60°.

The nozzle insert 3 is polished on the surface, on the inner side, and on the outer side.

FIG. 2 is a sectional view of a first alternative of the extrusion nozzle 1 from FIG. 1. In the shown cross section, the extrusion nozzle 1 has a continuous channel 5, in which the filament is transported during the processing of 3D printing material.

In the right part of the illustration, the extrusion nozzle 1 has a threaded seat 22 for screwing into the 3D printer.

In the left part of the illustration, the nozzle body 2 has an outlet portion 21, which is formed in one piece with the seat 22 made of solid carbide, metal, or brass.

At the front tip, the outlet portion 21 comprises a nozzle insert 3, which continues the channel 5 for the transport of the filament. In this alternative, the nozzle insert 3 is arranged at a connection piece 3a made of solid carbide.

In the case of the illustrated outlet portion 21, a recess 4 is formed on the end side, which has a hexagonal peripheral shape. The recess 4 has a depth and a lateral diameter that the nozzle insert 3, which is formed in a complementary manner, is received almost completely therein with its connection piece 3a. The nozzle insert 3, which is formed in such a complementary manner, has a lasered outer contour from all sides.

FIG. 3 is a sectional view of a second alternative of the extrusion nozzle from FIG. 1, wherein the nozzle insert 3 is formed without connection piece (see FIG. 3a).

At the front tip, the outlet portion 21 comprises a nozzle insert 3, which continues the channel 5 for the transport of the filament. In the shown example, the nozzle insert is made completely of PCD.

In the case of the illustrated outlet portion 21, a recess 4 is formed on the end side, which has a hexagonal peripheral shape. The recess 4 has a depth and a lateral diameter that the nozzle insert 3, which is formed in a complementary manner, is received almost completely therein. The nozzle insert 3, which is formed in such a complementary manner, has a lasered outer contour from all sides.

FIG. 4 is a front view of the extrusion nozzle 1 from FIGS. 1 and 2. The outlet portion 21 supports the nozzle insert 3 in a recess. The channel 5 serves for the transport of the filament.

1. A nozzle insert for a 3D printer, wherein:
the nozzle insert comprises a rear surface, and a front surface,
the rear surface defines a rear opening that has a first diameter,
the front surface defines a front opening,
the nozzle insert defines a nozzle insert channel that extends from the rear opening to the front opening,
the nozzle insert channel comprises a first nozzle insert channel portion and a second nozzle insert channel portion,
the first nozzle insert channel portion extends from the rear opening to an interface between the first nozzle insert channel portion and the second nozzle insert channel portion,
the second nozzle insert channel portion extends from the interface between the first nozzle insert channel portion and the second nozzle insert channel portion to the front opening, and
the first nozzle insert channel portion is tapered from the first diameter at the rear opening to a second diameter at the interface between the first nozzle insert channel portion and the second nozzle insert channel portion, the second diameter is smaller than the first diameter.

2. The nozzle insert recited in claim 1, wherein the nozzle insert is a one-piece integral structure.

3. The nozzle insert recited in claim 1, wherein the nozzle insert comprises two pieces that are joined together.

4. The nozzle insert recited in claim 1, wherein the second nozzle insert channel portion is cylindrical, and the second nozzle insert channel portion has a diameter that is equal to the second diameter.

5. The nozzle insert recited in claim 1, wherein the nozzle comprises a plurality of peripheral side surfaces.

6. The nozzle insert recited in claim 5, wherein the plurality of peripheral side surface comprises six side surfaces that together form a hexagonal shape.

7. The nozzle insert recited in claim 1, wherein the rear opening is circular.

8. The nozzle insert recited in claim 1, wherein the front opening is circular.

9. The nozzle insert recited in claim 1, wherein the nozzle insert comprises polycrystalline diamond material.

10. A nozzle body for a 3D printer, wherein:
the nozzle body comprises a rear surface and front region,
the rear surface comprises a rear nozzle body opening,
the front region comprises a recess,
the recess comprises a rear recess surface,
the rear recess surface comprises a front nozzle body opening, and
the nozzle body defines a nozzle body channel that extends from the rear nozzle body opening to the front nozzle body opening.

11. The nozzle body recited in claim 10, wherein the nozzle body channel is cylindrical.

12. The nozzle body recited in claim 10, wherein the nozzle body further comprises a threaded seat for screwing into a 3D printer.

13. The nozzle body recited in claim 10, wherein the recess comprises a plurality of recess side surfaces

14. The nozzle body recited in claim 13, wherein the plurality of recess side surfaces comprises six recess side surfaces that together form a hexagonal shape.

15. The nozzle body recited in claim 10, wherein the nozzle body comprises at least one material selected from the group of materials consisting of solid carbide, metal and brass.

16. An extrusion nozzle, comprising:
a nozzle insert; and
a nozzle body,
the nozzle insert comprising a nozzle insert rear surface, and a nozzle insert front surface,
the nozzle insert rear surface defines a nozzle insert rear opening that has a first diameter,
the nozzle insert front surface defines a nozzle insert front opening,
the nozzle insert defines a nozzle insert channel that extends from the nozzle insert rear opening to the nozzle insert front opening,
the nozzle insert channel comprises a first nozzle insert channel portion and a second nozzle insert channel portion,
the first nozzle insert channel portion extends from the nozzle insert rear opening to an interface between the first nozzle insert channel portion and the second nozzle insert channel portion,
the second nozzle insert channel portion extends from the interface between the first nozzle insert channel portion and the second nozzle insert channel portion to the nozzle insert front opening,
the first nozzle insert channel portion is tapered from the first diameter at the nozzle insert rear opening to a second diameter at the interface between the first nozzle insert channel portion and the second nozzle insert channel portion, the second diameter is smaller than the first diameter,
the nozzle body comprises a nozzle body rear surface and nozzle body front region,
the nozzle body rear surface comprises a rear nozzle body opening,
the nozzle body front region comprises a recess,
the recess comprises a rear recess surface,
the rear recess surface comprises a front nozzle body opening, and
the nozzle body defines a nozzle body channel that extends from the rear nozzle body opening to the front nozzle body opening.

17. The extrusion nozzle recited in claim 16, wherein the recess has a recess size and a recess shape that are complementary to at least a portion of the nozzle insert.

18. The extrusion nozzle recited in claim 17, wherein:
the nozzle insert comprises six side surfaces that together form a hexagonal shape, and
the recess comprises six recess side surfaces that together form a hexagonal shape.

19. The extrusion nozzle recited in claim 16, wherein the second nozzle insert channel portion is cylindrical, and the second nozzle insert channel portion has a diameter that is equal to the second diameter.

20. The extrusion nozzle recited in claim 16, wherein the nozzle insert rear opening is circular.

21. The extrusion nozzle recited in claim 16, wherein the nozzle insert front opening is circular.

22. The extrusion nozzle recited in claim 16, wherein the nozzle insert comprises polycrystalline diamond material.
